(19) United States
(12) Patent Application Publication
(10) Pub. No.: US 2025/0144661 A1
(43) Pub. Date: May 8, 2025

(54) COATING DEVICE

(71) Applicant: TORAY ENGINEERING CO., LTD., Tokyo (JP)

(72) Inventors: Takayuki MIYOSHI, Uji-city (JP); Toshiaki IKADA, Otsu-shi (JP); Toshifumi ITO, Moriyama-shi (JP)

(21) Appl. No.: 19/014,658

(22) Filed: Jan. 9, 2025

Related U.S. Application Data
(63) Continuation of application No. PCT/JP2023/018241, filed on May 16, 2023.

(30) Foreign Application Priority Data
Jul. 11, 2022 (JP) 2022-111343

(51) Int. Cl. B05C 5/00; B05C 5/02; F26B 21/12

(52) U.S. Cl. CPC B05C 5/001; B05C 5/0208; F26B 21/12

(57) ABSTRACT

A coating device comprises a stage, a coater and a dryer. A substrate is configured to be placed on the stage. The coater is configured to eject a coating liquid from a nozzle to form a coating film on the substrate that is placed on the stage while moving relative to the substrate. The dryer is configured to dry the coating film on the substrate. Drying promotion force of the dryer for promoting drying is adjusted on the basis of drying distribution information of the coating film on the substrate in accordance with a region of the coating film.

### CROSS-REFERENCE TO RELATED APPLICATIONS

This application is a continuation application of PCT International Application No. PCT/JP2023/018241 filed on May 16, 2023, which claims priority to Japanese Patent Application No. 2022-111343 filed on Jul. 11, 2022. The entire disclosures of PCT International Application No. PCT/JP2023/018241 and Japanese Patent Application No. 2022-111343 are hereby incorporated herein by reference.

### BACKGROUND

### Field of the Invention

This disclosure generally relates to a coating device for forming a coating film on a substrate, and more specifically, the present disclosure relates to a coating device capable of drying a coating film while preventing the crystal state of the coating film from becoming uneven.

### Background Information

In recent years, substrates having a uniform thin film formed thereon (called coated substrates) are being used for various purposes. For example, when forming a coating film having a uniform film thickness on a substrate, the coating film is formed using a coating device that has a slit-shaped nozzle.

### SUMMARY

For example, as shown in FIG. 9, a coating device according to a comparative example comprises a stage 100 on which a substrate W is placed and a coater 101 having a slit-shaped nozzle that ejects a coating liquid, the coating device and is configured such that the substrate W and the coater 101 are moved relative to each other while ejecting the coating liquid from the slit of the nozzle, thereby forming a coating film C having a prescribed thickness on the substrate W. The coated substrate W thus formed is taken out of the coating device and dried using a drying device 102 that is separate from the coating device.

However, in the coating device described above, it has been discovered that the coating film C cannot fully exhibit its functionality. That is, the functionality of some coating film C materials depend on the crystal state, such as materials used for perovskite solar cells. However, even if the coating film C formed with a coating device is dried in a uniform drying environment, such as in the drying device 102, the crystal state of the coating film C differs depending on the location, causing the problem of impaired functionality due to non-uniformity of the crystal state of the coating film C.

One object of the present disclosure is to provide a coating device capable of preventing the crystal state of the coating film that is formed from becoming uneven.

In view of the state of the known technology, a coating device of the present disclosure comprises a stage on which a substrate is configured to be placed, a coater configured to eject a coating liquid from a nozzle to form a coating film on the substrate that is placed on the stage while moving relative to the substrate, and a dryer configured to dry the coating film on the substrate. Drying promotion force of the dryer for promoting drying is adjusted on the basis of drying distribution information of the coating film on the substrate in accordance with a region of the coating film.

According to the coating device described above, the drying promotion force is adjusted on the basis of drying distribution information of the coating film in accordance with the region of the coating film, so the coating film can be dried while suppressing non-uniformity of the crystal state. That is, since it is possible to ascertain, from the drying distribution information, the dryness state of the regions of the coating film on the substrate, the drying promotion force of the dryer, that is, the output for drying, is adjusted on the basis of this drying distribution information in accordance with the region of the coating film. Specifically, an adjustment is made such that the drying promotion force is weakened for regions where the drying has relatively advanced, and the drying promotion force is strengthened for regions where the drying is relatively delayed. As a result, non-uniformity of the dryness state can be suppressed for the entire coating film, which makes it easier for the crystals of the coating film to grow large, thereby preventing the crystal state of the coating film from becoming uneven.

In accordance with a preferred embodiment according to the coating device mentioned above, the drying distribution information is periodically updated in accordance with a dryness state of the coating film that has been formed.

According to this configuration, even when the dryness state of the coating film changes with production, the drying distribution information is updated to respond to changes in the dryness state, thereby suppressing non-uniformity of the dryness state. The frequency of updating the drying distribution information may be for every substrate or for every several substrates.

In accordance with a preferred embodiment according to any one of the coating devices mentioned above, the drying distribution information is acquired from a dryness state of the coating film immediately after coating, and the coating film on the substrate is dried with the drying promotion force adjusted in accordance with the acquired drying distribution information.

According to this configuration, since the drying distribution information is acquired from the dryness state of the coating film immediately after coating, the drying promotion force can be adjusted in accordance with the dryness state of the coating film immediately after coating film formation. Accordingly, it is possible to carry out drying in accordance with the coating film that has been formed while suppressing non-uniformity of the dryness state.

In accordance with a preferred embodiment according to any one of the coating devices mentioned above, the dryer is provided to the coater and configured to carry out drying while the drying promotion force is being adjusted on the basis of the drying distribution information immediately after forming the coating film.

According to this configuration, since it is possible to carry out drying on the basis of the drying distribution information immediately after coating liquid lands on the substrate, it is possible to avoid a situation in which the dryness state becomes uneven immediately after the liquid lands due to natural drying.

In accordance with a preferred embodiment according to any one of the coating devices mentioned above, the dryer is configured to supply air to the coating film to carry out drying, and the drying promotion force is achieved by adjusting air supply amount of the dryer.

In accordance with a preferred embodiment according to any one of the coating devices mentioned above, the dryer is configured to supply air to the coating film to carry out drying, and the drying promotion force is achieved by adjusting a distance between the coating film and a supply port of the dryer from which air is discharged.

In accordance with a preferred embodiment according to any one of the coating devices mentioned above, the dryer has a shape that extends in a width direction orthogonal to a coating direction in which the coater moves unidirectionally to form the coating film, and the dryer has a supply port with sections divided in the width direction so that the air supply amount is adjusted for each section.

According to this configuration, since the supply port of the dryer has sections divided in the width direction, the drying promotion force can be adjusted by adjusting the amount of air supplied from each section.

In accordance with a preferred embodiment according to any one of the coating devices mentioned above, the supply port of the dryer may be configured such that the air supply amount is adjusted by setting an opening area for each of the sections.

According to this configuration, the amount of air supplied from the sections can be adjusted by appropriately adjusting the opening area for each of the sections.

According to the coating device of the present disclosure, it is possible to prevent the dryness state of the coating film from becoming uneven, thereby preventing the crystal state of the coating film that has been formed from becoming uneven.

### BRIEF DESCRIPTION OF THE DRAWINGS

FIG. 1 is a perspective view showing a coating device according to an embodiment of the present disclosure.

FIG. 2 is an enlarged elevational view showing the vicinity of a leg part of a coating unit.

FIG. 3 is a cross-sectional view of a coater provided with a dryer.

FIGS. 4A and 4B are diagrams of the dryer, with FIG. 4A being a plan view of the dryer as viewed from an air discharge part side and FIG. 4B showing a perspective view of a block member of the dryer.

FIG. 5 is a schematic diagram showing drying distribution information indicating the dryness state of each region of a coating film.

FIGS. 6A, 6B and 6C are diagrams showing the positions of the dryer and the adjustment states of the drying promotion force, with FIG. 6A showing a coating start end, FIG. 6B showing a central portion, and FIG. 6C showing a coating finish end.

FIG. 7 is a block diagram showing a control device of the coating device.

FIG. 8 is a diagram showing another embodiment.

FIG. 9 is a diagram showing a coating device and a drying device according to a comparative example.

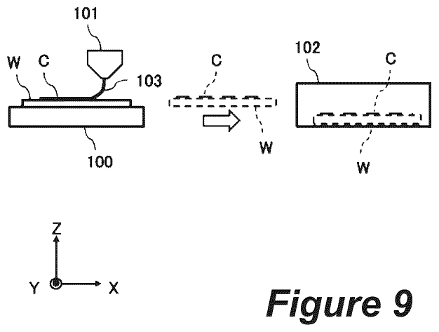

### DETAILED DESCRIPTION OF EMBODIMENTS

Selected embodiments according to the present disclosure will be described with reference to the drawings.

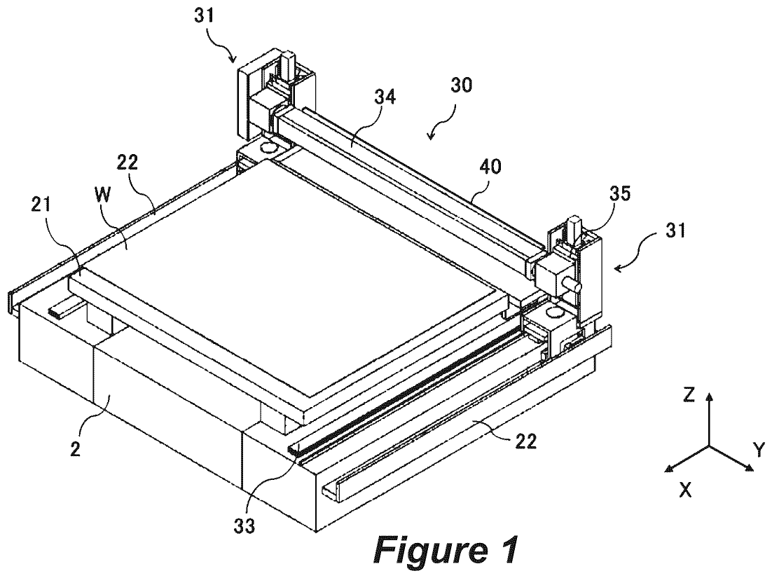

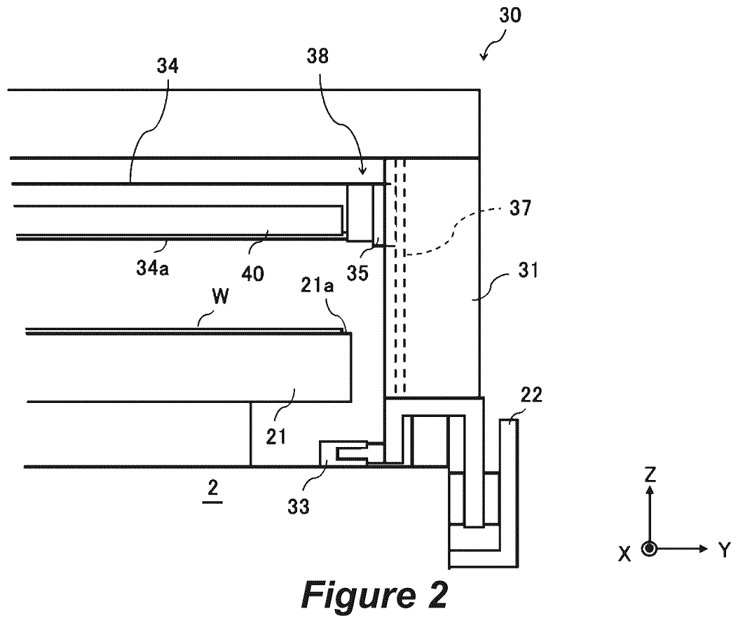

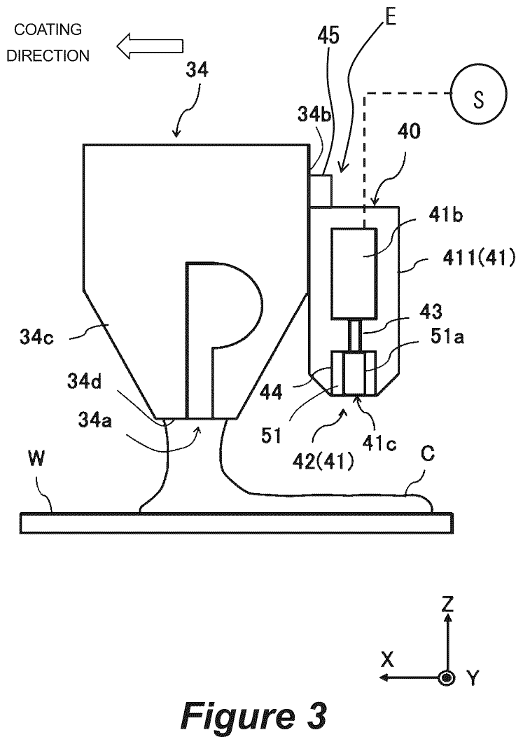

FIG. 1 is a perspective view schematically showing a coating device according to an embodiment of the present disclosure, FIG. 2 is an enlarged elevational view showing the vicinity of a leg part of the coating unit, and FIG. 3 is a cross-sectional view of a coater provided with a dryer.

As shown in FIGS. 1 to 3, the coating device forms, on a substrate W, a coating film C of a liquid material (hereinafter referred to as coating liquid), such as a chemical solution or a resist liquid, and the coating device comprises a base 2, a stage 21 on which the substrate W is placed, and a coating unit 30 configured to be capable of moving in a specific direction with respect to the stage 21.

In the following description, the direction in which the coating unit 30 moves is defined as the X-axis direction, the direction orthogonal thereto on a horizontal plane is defined as the Y-axis direction, and the direction orthogonal to both the X-axis direction and the Y-axis direction is defined as the Z-axis direction.

The stage 21 is disposed at the central portion of the base 2. This stage 21 is for placing a substrate W that has been transported thereon. This stage 21 is provided with a substrate mounting surface 21a on which the substrate W is placed and a substrate holding means or holder, and this substrate holding means is configured to hold the substrate W. Specifically, a plurality of suction holes are formed on the substrate mounting surface 21a of the stage 21 and suction force is generated in these suction holes, whereby it is possible to suction and hold the substrate W on the substrate mounting surface 21a.

In addition, the stage 21 is provided with a substrate elevating mechanism that raises and lowers the substrate W. Specifically, a plurality of pin holes are formed on the surface of the stage 21, and lift pins (not shown) that can be raised and lowered in the Z-axis direction are embedded in these pin holes. That is, when the substrate W is brought in, in a state in which the lift pins are protruding from the surface of the stage 21, the distal end portions of the lift pins come into contact with the substrate W and can hold the substrate W. From this state, by lowering and accommodating the lift pins in the pin holes, the substrate W can be placed on the substrate mounting surface 21a.

In addition, the coating unit 30 ejects a coating liquid onto the substrate W to form a coating film C. As shown in FIGS. 1 and 2, this coating unit 30 has leg parts 31 connected to the base 2 and a coater 34 that extends in the Y-axis direction, and the coating unit 30 is attached so as to be capable of moving in the X-axis direction while straddling the base 2 in the Y-axis direction. Specifically, rails 22 extending in the X-axis direction are provided at two ends of the base 2 in the Y-axis direction, and the leg parts 31 are attached to the rails 22 so as to be freely slidable. A linear motor 33 is attached to the leg parts 31 and, by controlling the driving of this linear motor 33, the coating unit 30 moves in the X-axis direction and can be stopped at any position. The linear motor 33 is not limited to the location shown in FIG. 2, and can be different location on the coating device.

In addition, as shown in FIG. 2, the coater 34 that applies the coating liquid is attached to the leg parts 31 of the coating unit 30. Specifically, the leg parts 31 are each provided with a rail 37 that extends in the Z-axis direction and a slider 35 that slides along the rail 37, and the slider 35 and the coater 34 are connected to each other. A ball screw mechanism driven by a servo motor 38 is attached to the slider 35, and by controlling the driving of this servo motor 38, the slider 35 moves in the Z-axis direction and can be stopped at any position. That is, the coater 34 is supported so as to be capable of contacting and moving away from the substrate W held by the stage 21. The servo motor 38 is not limited to the location shown in FIG. 2, and can be different location on the coating device.

In addition, as shown in FIGS. 1 to 3, the coater 34 ejects a coating liquid to form a coating film C on the substrate W. This coater 34 is a columnar member having a shape extending in one direction and is provided so as to extend in a direction substantially perpendicular to the traveling direction of the coating unit 30. Specifically, the coater 34 has a side surface portion 34b that extends in the vertical direction, and a substrate-facing surface 34d that faces the substrate W and that is separated from the side surface portion 34b by an inclined surface portion 34c that is formed having an inclined shape. A slit nozzle 34a is formed on the substrate-facing surface 34d, and the coating liquid is configured to be ejected from the slit nozzle 34a. That is, the slit nozzle 34a is formed extending in the longitudinal direction on the substrate-facing surface 34d of the coater 34, and coating liquid that is supplied to the coater 34 is configured to be uniformly ejected from the slit nozzle 34a along the longitudinal direction. Accordingly, by moving the coating unit 30 in the X-axis direction in a state in which the coating liquid is being ejected from the slit nozzle 34a, the coating film C of a constant thickness is formed on the substrate W along the longitudinal direction of the slit nozzle 34a. The direction in which the coating unit 30 is moved while ejecting the coating liquid from the slit nozzle 34a in order to apply the coating liquid will be referred to as the coating direction in the present embodiment (X-axis direction in the present embodiment), and the coating direction side is referred to as the coating progression side. The direction perpendicular to the coating direction is referred to as the width direction (Y-axis direction in the present embodiment).

In addition, the coater 34 is provided with a dryer 40. This dryer 40 is for drying the coating film C formed on the substrate W. Here, drying means not only complete drying but also includes drying to a semi-dried state, as well as drying to a degree at which crystallization of a material is promoted more than when leaving and drying in atmosphere.

In the present embodiment, the dryer 40 is integrally attached to the coater 34 so as to be adjacent on the side opposite to the coating progression side. That is, when the coater 34 moves in the coating progression direction while ejecting the coating liquid, the dryer 40 moves integrally with the coater 34, and the coating film C is dried by the dryer 40 immediately after the coating film C is formed on the substrate W.

The dryer 40 is provided along the longitudinal direction of the coater 34 and has an air blowing part 41 that supplies air. In the present embodiment, the air blowing part 41 is arranged adjacent to the coater 34.

The air blowing part 41 supplies air to the coating film C formed on the substrate W. In the present embodiment, the air blowing part 41 includes an air blower main body 411 and an air discharge part 42, and air stored in the air blower main body 411 is blown out through the air discharge part 42.

The air blower main body 411 has a box shape and is formed in a shape extending in the longitudinal direction along the side surface portion 34b of the coater 34. In the present embodiment, the air blower main body 411 is formed having a dimension longer than the longitudinal dimension of the slit nozzle 34a. In addition, a cavity 41b for storing air to be supplied to the coating film C is formed in the air blower main body 411, so that air supplied from an air supply source can be temporarily stored in the cavity 41b. In the present embodiment, the cavity 41b is formed divided into three portions in the longitudinal direction, and each of these divided portions is connected to the air discharge part 42 via a communication flow channel 43 formed narrower than the divided portion. Accordingly, when air is supplied to the cavity 41b, the air spreads into, and is temporarily stored in, each of the divided portions, and, by passing through the communication flow channel 43 formed narrower than the divided portions, the air is stably supplied to the air discharge part 42. In addition, in the present embodiment, air supply sources S are independently connected to the three divided portions of the cavity 41b, so that the air supply amount to each divided portion can be adjusted.

The air discharge part 42 is for guiding the air supplied to the air blower main body 411 to the coating film C. Openings 41c (e.g., a supply port of the dryer 40 of the present disclosure) are formed in the air discharge part 42, and air is supplied to the coating film C through these openings 41c.

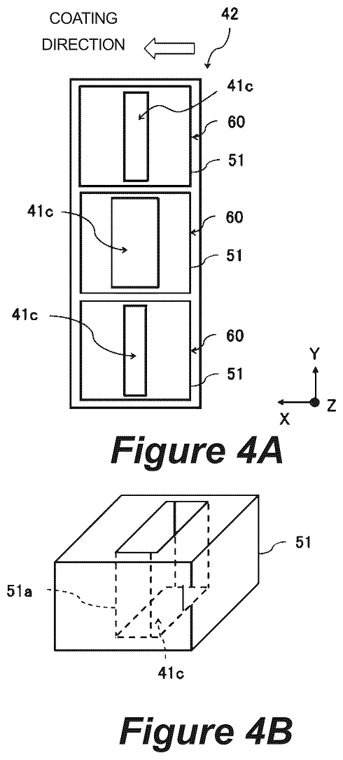

In the present embodiment, the air discharge part 42 is formed of block members 51 (see FIG. 4B) each forming the opening 41c. That is, a block housing portion 44 for housing the block members 51 is formed at the distal end portion of the air blower main body 411, and air is supplied through these block members 51. That is, a supply flow channel 51a for guiding the air is formed in each block member 51, and the opening 41c is formed on the substrate W side of each block member 51. The supply flow channels 51a are configured to communicate with the communication flow channels 43 when the block members 51 are housed in the block housing portion 44. As a result, the air supplied to the cavity 41b is supplied to the coating film C via the communication flow channels 43, the supply flow channels 51a, and the openings 41c.

In addition, the air discharge part 42 is formed such that air volume is adjusted in the longitudinal direction. Specifically, a plurality of sections 60 are formed in the longitudinal direction of the air discharge part 42. In the present embodiment, three sections 60 are formed, as shown in FIG. 4A. The air volume can be adjusted for each of these sections 60.

Here, FIG. 4A is a plan view of the dryer 40 as viewed from the air discharge part 42 side, and the air discharge part 42 is formed of three sections 60. As shown in FIG. 4A, in the present embodiment, the sections 60 are formed of the block members 51, respectively. Specifically, the sections 60 are formed by three of the block members 51 being arranged and housed in the block housing portion 44 in the longitudinal direction. That is, the three block members 51 are connected to the divided portions of the cavity 41b via the communication flow channels 43. As a result, the air supplied from the divided portions of the cavity 41b is supplied via the communication flow channels 43 and the openings 41c of the block members 51, and, by adjusting the air volume of the air supply source S for each divided portion of the cavity 41b, the air volume (air supply amount) can be adjusted for each of the sections 60.

In addition, as shown in FIG. 4A, an opening area of the opening 41c formed in the block member 51 is set for each of the sections 60. In the present embodiment, as shown in FIG. 4A, for example, the openings 41c located at the two ends in the longitudinal direction have opening areas that are set to be smaller than that of the opening 41c located in the center. It is thereby possible to adjust the air supply amount in the longitudinal direction of the air discharge part 42. That is, it is possible to reduce the air supply amount at the two ends in the longitudinal direction and to increase the air supply amount at the central position compared to the two ends in the longitudinal direction.

In this manner, it is possible to adjust the air supply amount to the coating film C to adjust the drying promotion force for promoting the dryness state of the coating film C. This drying promotion force is the degree to which the dryness state of the coating film C is promoted, in which the dryness state is advanced by removing moisture and volatile components from the coating film C. In the present embodiment, the drying promotion force is adjusted by varying the air supply amount, which can be adjusted by changing the amounts of air supplied from the air supply sources S or the opening areas of the openings 41c. For example, if the amounts of air supplied from the air supply sources S are the same, the air volume is larger in the section 60 having the opening 41c with large opening area, thereby relatively promoting drying, and the air volume is smaller in the sections 60 having the openings 41c with small opening areas, thereby relatively suppressing the promotion of drying. In addition, the air supply amount of the entire air discharge part 42 can be adjusted by adjusting the amounts of air of the air supply sources S, thereby adjusting the drying promotion force. Furthermore, by adjusting the air supply amount for each of the sections 60, the drying promotion force can be more finely adjusted for each of the sections 60 compared to an adjustment by means of the opening area of the block member 51.

In addition, these block members 51 are each formed as a single body, as shown in FIG. 4B, and can thus be replaced. For example, the block members 51 located at the two longitudinal ends can be replaced with the block member 51 in the center. A plurality of types of the block members 51 with different opening areas are prepared, so the arrangement of the block members 51 can be freely rearranged to adjust the air volume blown onto the coating film C and to freely adjust the drying promotion force in advance.

In addition, the dryer 40 is formed such that the height position with respect to the coating film can be adjusted. In the present embodiment, the side surface portion 34b of the coater 34 is provided with an elevating mechanism E having a rail extending the Z-axis direction and a slider that moves along the rail. The slider is attached to the dryer 40 and is driven by an actuator 45, such as a ball screw mechanism with a servo motor, etc. By controlling the driving of this elevating mechanism (i.e., by controlling the driving of the actuator 45), the dryer 40 shifts in the Z-axis direction relative to the coater 34, thereby adjusting the height position of the dryer 40. As a result, it is possible to adjust the height position of the dryer 40 to adjust the amount of the air supplied from the air discharge part 42 to the coating film C. That is, by adjusting the height position of the dryer 40, the volume of air that reaches the coating film C is adjusted, thereby adjusting the air supply amount, and, as a result, the drying promotion force can be adjusted. The actuator 45 is not limited to the location shown in FIG. 3, and can be different location on the coating device.

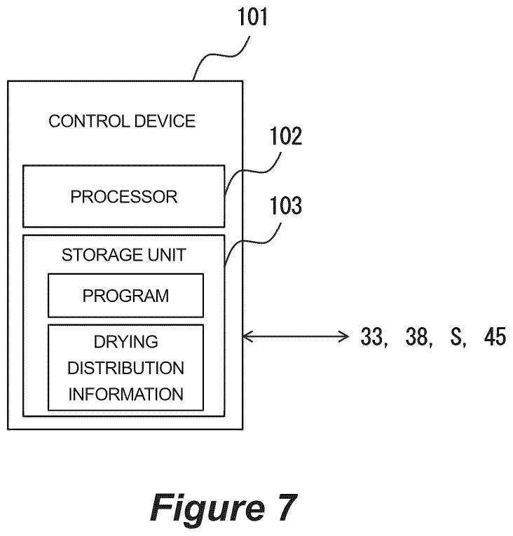

In addition, the coating device described above has a control device or controller 101. As illustrated in FIG. 7, the control device 101 includes at least one processor 102 having a CPU (Central Processing Unit) and the like, a storage unit 103 (computer memory) having a ROM (Read Only Memory), a RAM (Random Access Memory) 103, a storage device, and the like. The storage device can be a hard disk drive, a semiconductor storage device and the like. Furthermore, the control device 101 can also include a display unit (display) such as a liquid crystal display device, a user interface having an input device such as a keyboard and a mouse, and a reader for reading the program and/or various data from a recording medium. The control device 101 is configured to control the driving of various drive devices described above, and controls the driving of the drive device of each unit and carries out various computations necessary for the coating operation, in order to execute a series of processing operations in accordance with a pre-stored program. Specifically, the control device 101 is operatively connected to the substrate holding means to hold the substrate W on the substrate mounting surface 21a. The control device 101 is operatively connected to the substrate elevating mechanism to operate the lift pins to place the substrate on the substrate mounting surface 21a. The control device 101 is operatively connected to the linear motor 33 of the coating unit 30 to move the coater 34 of the coating unit 30 in the X-axis direction. The control device 101 is operatively connected to the servo motor 38 of the coating unit 30 to move the coater 34 of the coating unit 30 in the Z-axis direction. The control device 101 is operatively connected to actuators or valves of the air supply sources S to adjust the air supply amount of the air discharge part 42 of the dryer 40, thereby adjusting the drying promotion force of the dryer 40 in a manner described later. The control device 101 is operatively connected to the actuator 45 to adjust the height position of the dryer 40 in the Z-axis direction, thereby adjusting the drying promotion force of the dryer 40 in a manner described later.

The storage unit 103 of the control device 101 stores drying distribution information for controlling the drying promotion force of the dryer 40. The drying distribution information is information indicating the drying distribution of the coating film C on the substrate W formed by the coater 34, and is data in which regions (locations) of the coating film C on the substrate W are associated with dryness states. The control device 101 adjusts the drying promotion force for regions of the coating film C on the basis of the drying distribution information.

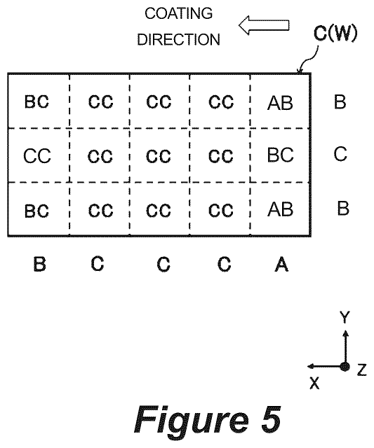

Specifically, in the drying distribution information, regions (sites) of the coating film C are associated with dryness states. In the example shown in FIG. 5, the coating film C is formed divided into five regions in the coating direction (X-axis direction) and three regions in the width direction (Y-axis direction), and the dryness state of each region is understood. In FIG. 5, the degree of dryness is indicated in relative terms from A to C, where A indicates areas where drying has relatively progressed the most, and B and C indicate areas of lesser and lesser progression of drying in that order. For example, in the coating direction, portions that are coated first (right end side of the coating film C in FIG. 5) are indicated by As, indicating that drying has progressed. The central portion of the coating film C is indicated by Cs, indicating that drying has not relatively progressed because the portion is surrounded by the coating film C. Similarly for the width direction, the degree of dryness is indicated from A to C, and the dryness state is indicated for each of the fifteen regions of the coating film C in the order of the coating direction and the width direction, such as AB, CC, and the like. For example, the two width-direction ends of the portions that are coated first (right end side of the coating film C in FIG. 5) have the dryness state of AB, the dryness state of the central portion is BC, and the width-direction ends of the final end in the coating direction (left end side of the coating film C in FIG. 5) have the dryness state of BC.

Such drying distribution information is obtained and stored in the storage unit 103 in advance by acquiring dryness state data from the coating film C that has been formed. That is, the dryness state of each region is ascertained by forming the coating film C with the coater 34 under a preset coating condition and observing the surface of the coating film C, and this dryness state is used as the drying distribution information for the coating condition. One piece of drying distribution information acquired in advance may be always used, or, drying distribution information periodically acquired in advance may be appropriately updated and used in accordance with the operating time of the coating device, the lot, and the like.

The control device 101 adjusts the drying promotion force of the dryer 40 on the basis of this drying distribution information. That is, the drying promotion force is adjusted by setting the amount of air ejected from the dryer 40 and the height position of the openings 41c in accordance with the dryness state AA to CC of each region of the coating film C and the opening areas of the block members 51 attached to the dryer 40. In the present embodiment, the air volume and the height position of the openings 41c are adjusted in consideration of the point that the opening area is set larger for the block members 51 at both ends in the width direction than the block member 51 at the center.

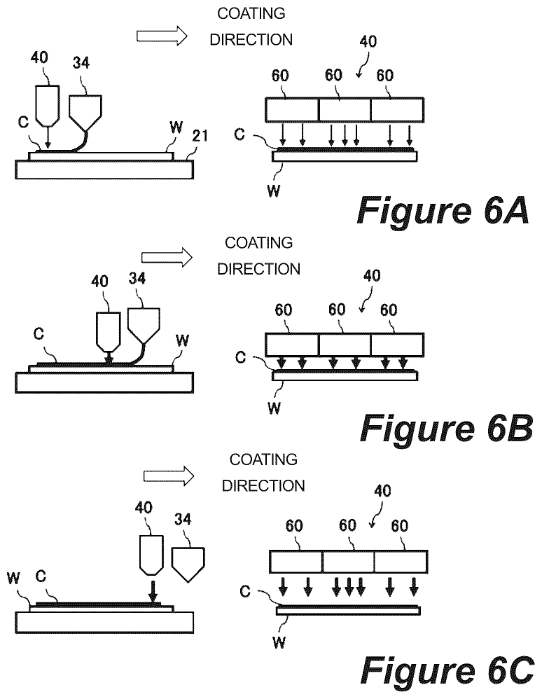

Here, FIGS. 6A, 6B and 6C shows the adjustment states of the drying promotion force of the dryer 40, with FIG. 6A showing a coating start end, FIG. 6B showing a central portion, and FIG. 6C showing a coating finish end. In each of FIGS. 6A, 6B and 6C, the left-hand diagram is a view from the Y-axis direction and the right-hand diagram is a view from the X-axis direction. In FIGS. 6A, 6B and 6C, the size and thickness of the arrows schematically indicate the air supply amount.

As shown in FIG. 6A, at the coating start end, the dryness states are AB at the two width-direction ends and BC at the central portion, so the drying promotion force is adjusted to be greater at the central portion than the two width-direction ends. Specifically, as shown in the right-hand diagram of FIG. 6A, by setting the amount of air supplied from the air supply sources S to be the same, the amount of air supplied from the block member 51 at the center is adjusted to be greater than the amount of air supplied from the block members 51 at the two ends of the air discharge part 42 due to the difference in the opening areas of the block members 51, so that the dryness state of the coating film C at the central portion is promoted more than the coating film C at the two width-direction ends.

Next, since the dryness states are all CC at the center in the coating direction, the drying promotion force is adjusted to be greater than the setting for the coating start end. Specifically, the height position of the dryer 40 is adjusted to a position closer to the coating film C than when at the coating start end. The amount of air supplied from the air supply sources S is adjusted to be large and so that about the same amount of air is supplied from all of the block members 51 of the air discharge part 42. As a result, the amount of air supplied to the coating film C along the width direction increases for the coating film C at the center in the coating direction, thereby promoting the dryness state compared to the coating start end.

Next, at the coating finish end, since the dryness states are CC at the width-direction center and BC at the two width-direction ends, the drying promotion force is adjusted to be greater at the width-direction center than at the two width-direction ends. In addition, since the dryness state of the coating finish end is not as advanced as that of the coating start end, the drying promotion force is adjusted to be greater at the coating finish end than at the coating start end. Specifically, the height position of the dryer 40 is returned to the same height position as at the coating start end and the amount of air supplied from the air supply sources S is adjusted to be greater than at the coating start end. As a result, the drying promotion force is adjusted to be greater than at the coating start end. It should be noted that the drying promotion force at the width-direction center position becomes larger with this adjustment due to the differences in the opening areas of the block members 51 even if the amount of air supplied from the air supply sources S is constant. However, the drying promotion force may be adjusted to be even greater for the coating film C at the width-direction center by adjusting the amount of air supplied from the air supply source to be greater at the width-direction center.

In this manner, according to the coating device of the embodiment described above, the drying promotion force is adjusted on the basis of the drying distribution information of the coating film C in accordance with the region of the coating film C, so that the coating film C can be dried while suppressing non-uniformity of the crystal state. That is, since it is possible to ascertain, from the drying distribution information, the dryness state for each region of the coating film C on the substrate W, the drying promotion force of the dryer 40, that is, the output for drying, is adjusted on the basis of this drying distribution information in accordance with the region of the coating film C. Specifically, an adjustment is made such that the drying promotion force is weakened for regions where the drying has relatively advanced, and the drying promotion force is strengthened for regions where the drying is relatively delayed. As a result, non-uniformity of the dryness state can be suppressed for the entire coating film C, which makes it easier for the crystals of the coating film C to grow large, thereby preventing the crystal state of the coating film C from becoming uneven.

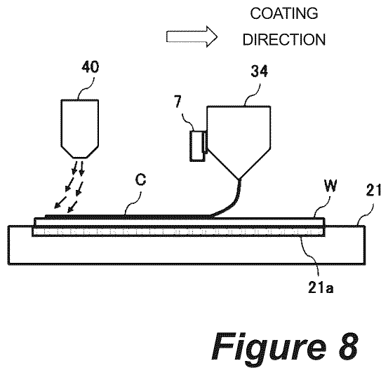

In addition, in the embodiment described above, an example is described in which the drying distribution information to be used is acquired in advance through experiments and the like, but the present invention is not limited to this. The drying distribution information to be used may be acquired from the dryness state of the coating film C immediately after formation of the coating film C. For example, as shown in FIG. 8, a camera 7 that can observe the surface of the coating film C may be provided on the side of the coater 34 opposite to the coating progression side, the drying distribution information may be created on the basis of dryness information obtained from this camera 7, and the dryer 40 may be controlled on the basis of this drying distribution information. Specifically, the stage 21 is provided with a heater 21a that dries the coating film C formed on the substrate W, drying of the coating liquid is started immediately after the coating liquid is ejected from the coater 34 and lands, thereby forming the coating film C. The dryness state is ascertained by the control device 101 from image information of the coating film C captured by the camera 7 to create the drying distribution information. In other words, the control device 101 captures the image of the surface of the coating film C, determines the dryness state of the coating film C and creates the drying distribution information based on the dryness state. Then, the drying promotion force of the dryer 40 that follows behind the coater 34 may be adjusted on the basis of the drying distribution information.

In addition, according to the embodiment described above, an example is described in which the dryer 40 and the coater 34 are integrated, but the present invention is not limited to this. The dryer 40 and the coater 34 may be provided as separate units. While being integrated is preferable in that the dryness state can be controlled from immediately after coating, in a configuration where the dryness state is fed back in real-time, since there is time to ascertain the dryness state, the overall equipment cost can be contained as there is no need to use a high-performance PC for the control device 101.

Additionally, in the embodiment described above, an example is described in which there are three sections 60 of the air discharge part 42, but the number of sections may be two, or greater than three. A greater number of the sections 60 allows a more fine-tuned response to the drying distribution information of the coating film C. In addition, the number of the sections 60 of the air discharge part 42 may be one. Although the ability to respond to the drying distribution information will decrease by eliminating the sections 60, the configuration is simplified so the device cost can be reduced.

In addition, in the embodiment described above, an example is described in which the drying promotion force is adjusted by adjusting the air supply amount, the height position of the dryer 40, and the opening areas of the block members 51, but the present invention is not limited to this. It is not necessary to be able to adjust all of the foregoing; rather, any may be selected as the target of adjustment. Furthermore, the drying promotion force may be adjusted by means other than an air supply means, such as with a heater, a suction means, or the like.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A coating device, comprising
a stage on which a substrate is configured to be placed;
a coater configured to eject a coating liquid from a nozzle to form a coating film on the substrate that is placed on the stage while moving relative to the substrate; and
a dryer configured to dry the coating film on the substrate,
drying promotion force of the dryer for promoting drying being adjusted on the basis of drying distribution information of the coating film on the substrate in accordance with a region of the coating film.

2. The coating device according to claim 1, wherein
the drying distribution information is periodically updated in accordance with a dryness state of the coating film that has been formed.

3. The coating device according to claim 1, wherein
the drying distribution information is acquired from a dryness state of the coating film immediately after coating, and
the coating film on the substrate is dried with the drying promotion force adjusted in accordance with the acquired drying distribution information.

4. The coating device according to claim 1, wherein
the dryer is provided to the coater and configured to carry out drying while the drying promotion force is being adjusted on the basis of the drying distribution information immediately after forming the coating film.

5. The coating device according to claim 1, wherein
the dryer is configured to supply air to the coating film to carry out drying, and
the drying promotion force is achieved by adjusting air supply amount of the dryer.

6. The coating device according to claim 1, wherein
the dryer is configured to supply air to the coating film to carry out drying, and
the drying promotion force is achieved by adjusting a distance between the coating film and a supply port of the dryer from which air is discharged.

7. The coating device according to claim 5, wherein
the dryer has a shape that extends in a width direction orthogonal to a coating direction in which the coater moves unidirectionally to form the coating film, and
the dryer has a supply port with sections divided in the width direction so that the air supply amount is adjusted for each of the sections.

8. The coating device according to claim 7, wherein
the supply port of the dryer is configured such that the air supply amount is adjusted by setting an opening area for each of the sections.

9. The coating device according to claim 5, wherein
the drying promotion force is achieved by adjusting a distance between the coating film and a supply port of the dryer from which air is discharged.
